(19) United States
(12) Patent Application Publication
(10) Pub. No.: US 2026/0129670 A1
(43) Pub. Date: May 7, 2026

(54) WIRELESS COMMUNICATION DEVICE AND METHOD FOR INTRA-BSS INTERFERENCE MITIGATION VIA NON-PRIMARY CHANNEL ACCESS

(71) Applicant: MEDIATEK INC., Hsinchu City (TW)

(72) Inventors: Hao-Hua Kang, Hsinchu City (TW); Cheng-Ying Wu, Hsinchu City (TW); Chih-Chun Kuo, Hsinchu CIty (TW); Chien-Feng Hsu, Hsinchu City (TW)

(73) Assignee: MEDIATEK INC., Hsinchu City (TW)

(21) Appl. No.: 19/366,458

(22) Filed: Oct. 22, 2025

Related U.S. Application Data
(60) Provisional application No. 63/714,953, filed on Nov. 1, 2024.

(51) Int. Cl. H04W 74/00

(52) U.S. Cl. CPC H04W 74/002

(57) ABSTRACT

A method and device for mitigating intra-BSS interference in a wireless network are disclosed. A wireless communication device detects a first physical layer protocol data unit (PPDU) on a primary channel. The device determines if the first PPDU is an intra-BSS transmission and not directed to itself. If both conditions are met, the device initiates a non-primary channel access (NPCA) procedure to allow the device to communicate on an idle non-primary channel by transmitting or receiving a second PPDU, thereby avoiding contention on the busy primary channel.

### CROSS REFERENCE TO RELATED APPLICATIONS

This application claims the benefit of U.S. Provisional Application No. 63/714,953, filed on November 1st, 2024. The content of the application is incorporated herein by reference.

### BACKGROUND

Wireless communication technology has become an indispensable part of modern life. Among these technologies, Wi-Fi^{®}, based on the Institute of Electrical and Electronics Engineers (IEEE) 802.11 series of standards for wireless local area networks (WLAN), has been widely adopted in various settings such as homes, offices, and public spaces due to its convenience and high-speed transmission characteristics. Wi-Fi^{®} is a registered trademark of Wi-Fi Alliance. For readability and conciseness throughout this specification, the term “Wi-Fi” will subsequently be used to refer to its respective technologies without repeated use of the trademark symbol ®. This usage is for descriptive purposes and is not intended to challenge the validity or ownership of the trademark. Consistent with the above, the term will be used descriptively without repeated trademark symbols. To enhance transmission rates, more recent generations of Wi-Fi standards (e.g., 802.11ac, 802.11ax, and 802.11be) employ channel bonding technology, which combines multiple narrower bandwidths (e.g., 20MHz) into a wider transmission bandwidth (e.g., 80MHz, 160MHz, or 320MHz). Within a wideband channel, a "primary channel" is typically designated for tasks such as contention-based access and transmission of control frames, while the remaining channels are referred to as "non-primary channels" or "secondary channels".

In a Wi-Fi network, all wireless devices, including the access point (AP) and stations (STAs), must first listen to determine if a channel is idle before transmitting. If the channel is detected as being in use, the transmission must be deferred. However, in high-density deployment environments, the coverage area of one basic service set (BSS) often overlaps with that of an "overlapping BSS" (OBSS) established by a different AP. When a device in the OBSS transmits on the primary channel, devices within the current BSS must defer their own transmissions, even if non-primary channels are idle. This scenario is an example of Inter-Basic Service Set (inter-BSS) interference, which refers to interference caused by transmissions from devices in a different, overlapping BSS. This inter-BSS interference significantly reduces the utilization efficiency of bandwidth resources.

To address this issue, the IEEE 802.11bn standard has formally defined a "non-primary channel access" (NPCA) mechanism as one of the main features in Wi-Fi 8. According to the conventional NPCA mechanism, when an AP or a STA within a BSS detects a signal from an OBSS on the primary channel, it can communicate on a pre-negotiated non-primary channel until the OBSS transmission ends, at which point it switches back to the primary channel. This approach allows devices to bypass the occupied primary channel and utilize idle non-primary channels for transmission, thereby improving channel utilization in the presence of OBSS interference.

However, the conventional NPCA mechanism is primarily designed to address inter-BSS interference and fails to consider the underutilization of bandwidth caused by Intra-Basic Service Set (intra-BSS) interference. Unlike inter-BSS interference, intra-BSS interference originates from other devices operating within the same BSS. Inside a BSS, when the AP is communicating with a certain STA, it also occupies the primary channel, causing other devices within the BSS to wait.

This problem is particularly pronounced in network environments that utilize a "tunneled direct link setup" (TDLS). TDLS allows two non-Access Point (non-AP) STAs to establish a peer-to-peer (P2P) connection directly without forwarding through the AP. A “non-AP” STA refers to a wireless station that is not functioning as an access point (AP) within the network. When the AP is communicating with one STA, two STAs engaged in TDLS communication will also be blocked upon detecting that the primary channel is busy, preventing them from effectively utilizing idle non-primary channels. Although TDLS devices can perform an off-channel operation to switch to a completely different channel, this process is often time-consuming and interrupts the connection with the AP, making it an inefficient solution.

Therefore, a need exists in the art for a method that can effectively utilize spectrum resources to address the problem of intra-BSS interference.

### SUMMARY

An embodiment of the present invention provides a wireless communication device operating in a basic service set (BSS). The wireless communication device comprises a transceiver and a processor. The transceiver is configured to receive and transmit a plurality of physical layer protocol data units (PPDUs) on a primary channel and a non-primary channel. The processor is coupled to the transceiver and is configured to detect a first PPDU via the primary channel, to determine that the first PPDU is an intra-BSS transmission corresponding to the BSS, to determine that the first PPDU is not directed to the wireless communication device, and to control the transceiver to perform a non-primary channel access (NPCA) procedure on the non-primary channel to transmit or receive a second PPDU in response to determining that the first PPDU is the intra-BSS transmission and is not directed to the wireless communication device.

Another embodiment of the present invention provides a non-primary channel access (NPCA) method for a first wireless communication device. The first wireless communication device and a second wireless communication device operate in a basic service set (BSS) and communicate via a tunneled direct link setup (TDLS). The NPCA method comprises detecting, on a primary channel, a first physical layer protocol data unit (PPDU); determining that the first PPDU is an intra-BSS transmission corresponding to the BSS; determining that the first PPDU is not directed to the first wireless communication device; in response to determining that the first PPDU is the intra-BSS transmission and is not directed to the first wireless communication device, switching to a non-primary channel; and communicating with the second wireless communication device on the non-primary channel.

Another embodiment of the present invention provides a non-primary channel access (NPCA) method for a first wireless communication device operating in a basic service set (BSS). The BSS further comprises a second wireless communication device and a third wireless communication device, wherein the second wireless communication device and third wireless communication device communicate via a tunneled direct link setup (TDLS). The NPCA method comprises detecting, on a primary channel, a first physical layer protocol data unit (PPDU) transmitted by the second wireless communication device or the third wireless communication device; determining that the first PPDU is an intra-BSS transmission corresponding to the BSS; determining that the first PPDU is not directed to the first wireless communication device; and in response to determining that the first PPDU is the intra-BSS transmission and is not directed to the first wireless communication device, performing an NPCA procedure on a non-primary channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an embodiment of the present invention.

FIG. 2 is a functional block diagram of the wireless communication system in FIG. 1.

FIG. 3 is a timing diagram illustrating a non-AP station performing tunneled direct link setup (TDLS) executing non-primary channel access (NPCA) upon detecting an intra-BSS downlink (DL) physical layer protocol data unit (PPDU), according to an embodiment of the present invention.

FIG. 4 is a timing diagram illustrating a non-AP station performing tunneled direct link setup (TDLS) executing non-primary channel access (NPCA) upon detecting an intra-BSS uplink (UL) PPDU, according to another embodiment of the present invention.

FIG. 5 is a timing diagram illustrating an access point and a non-AP station executing non-primary channel access (NPCA) upon detecting an intra-BSS PPDU from a tunneled direct link setup (TDLS), according to yet another embodiment of the present invention.

### DETAILED DESCRIPTION

To describe the present invention in detail, embodiments are provided with reference to the drawings. Those skilled in the art will understand that the following embodiments are for illustrative purposes only and are not intended to limit the scope of the present invention. Furthermore, for the sake of brevity, well-known components may be omitted from the drawings.

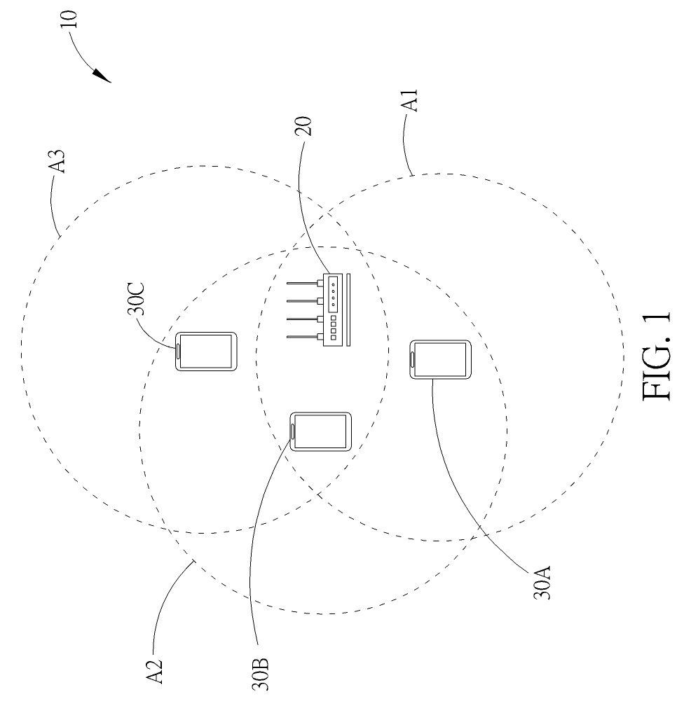

Please refer to FIG. 1, which illustrates a schematic diagram of a wireless communication system 10 according to an embodiment of the present invention. The wireless communication system 10 may be a wireless local area network (WLAN), such as a Wi-Fi system, which includes an access point (AP) 20 and a plurality of wireless communication devices 30A, 30B, and 30C. In this embodiment, the access point 20 establishes a basic service set (BSS), and the wireless communication devices 30A, 30B, and 30C operate as stations (STAs) within this BSS. Specifically, since the wireless communication devices 30A, 30B, and 30C are not operating as the access point 20, they may be referred to as non-Access Point (non-AP) stations. The wireless communication devices 30A, 30B, and 30C can include, but are not limited to, smartphones, laptop computers, tablet computers, Internet of Things (IoT) devices, or any other electronic equipment with wireless communication capabilities.

As shown in FIG. 1, the dashed circles A1, A2, and A3 represent the signal coverage of the wireless communication devices 30A, 30B, and 30C, respectively. The access point 20 is located within the overlapping area of these signal coverages and is therefore able to communicate with all the wireless communication devices 30A, 30B, and 30C.

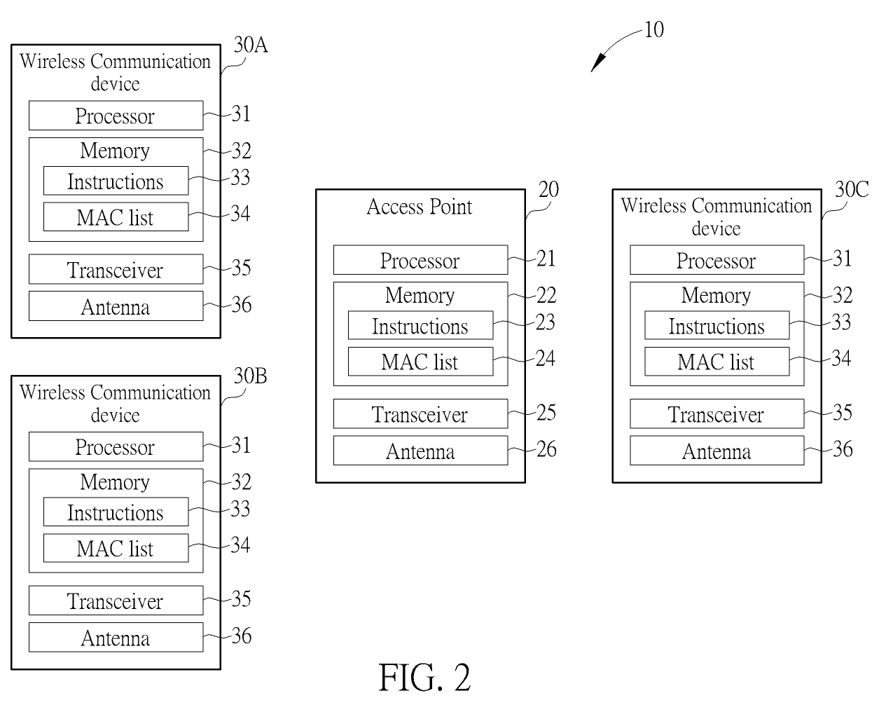

Please continue to refer to FIG. 2, which illustrates a functional block diagram of the wireless communication system 10 in FIG. 1. The access point 20 includes a processor 21, a memory 22, a transceiver 25, and at least one antenna 26. The memory 22 stores a plurality of instructions 23 and a media access control (MAC) address list 24. Similarly, each of the wireless communication devices 30A, 30B, 30C includes a processor 31, a memory 32, a transceiver 35, and at least one antenna 36. The memory 32 stores a plurality of instructions 33 and a media access control (MAC) address list 34.

In the access point 20, the processor 21 is coupled to the memory 22 and the transceiver 25. The processor 21 can access and execute the instructions 23 stored in the memory 22 to control the overall operation of the access point 20 and implement the methods disclosed in the present invention. The transceiver 25 is coupled to the antenna 26 for receiving and transmitting wireless signals via the antenna 26.

In the wireless communication devices 30A, 30B, 30C, the processor 31 is coupled to the memory 32 and the transceiver 35. The processor 31 can access and execute the instructions 33 stored in the memory 32 to control the overall operation of the wireless communication device and implement the methods disclosed in the present invention. The transceiver 35 is coupled to the antenna 36 for receiving and transmitting wireless signals, such as a plurality of physical layer protocol data units (PPDUs), on a primary channel and at least one non-primary channel as defined within the BSS.

The MAC address lists 24 and 34 can be used to store the media access control addresses of other devices within the same basic service set (BSS) as the access point 20 or the wireless communication devices 30A, 30B, 30C, which facilitates the subsequent handling of hidden node situations.

It should be noted that although each device is shown with only a single antenna 26 or 36 in FIG. 2, a person of ordinary skill in the art would understand that the access point 20 and the wireless communication devices 30A, 30B, and 30C can also be configured with a plurality of antennas to support advanced communication technologies such as multiple-input multiple-output (MIMO), thereby enhancing transmission performance.

The processors 21 and 31 may be central processing units (CPUs), microcontrollers (MCUs), digital signal processors (DSPs), application-specific integrated circuits (ASICs), field-programmable gate arrays (FPGAs), or other logic circuits. The memories 22 and 32 may be random-access memory (RAM), read-only memory (ROM), flash memory, or any form of non-transitory computer-readable medium. The transceivers 25 and 35 include the necessary circuitry for processing radio frequency (RF) signals. The functions disclosed in the present invention may be implemented through hardware, software, firmware, or any combination thereof.

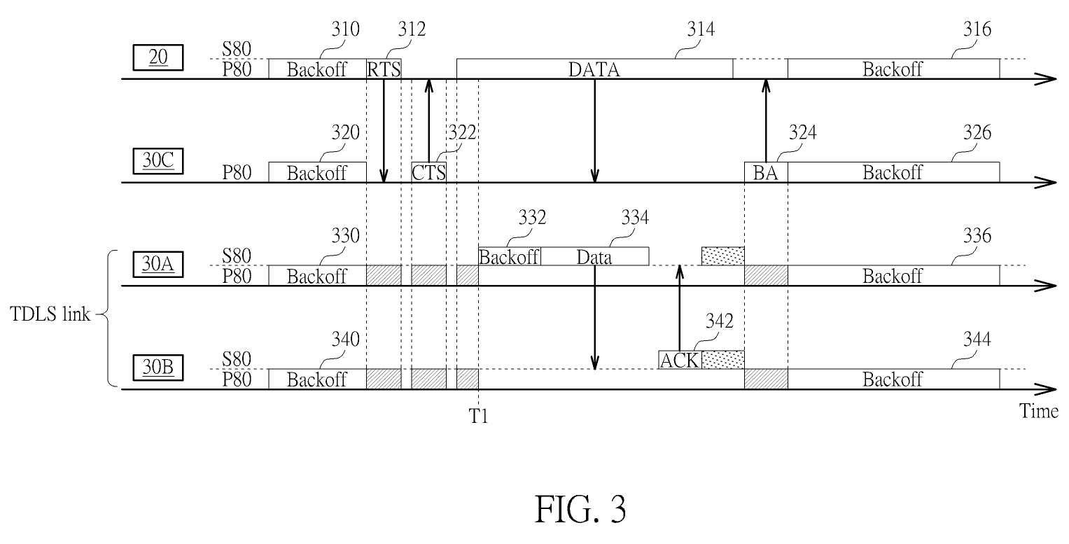

Please refer to FIG. 3, which illustrates a timing diagram according to an embodiment of the present invention, for explaining how wireless communication devices 30A and 30B, having established a TDLS link, execute a non-primary channel access (NPCA) procedure upon detecting an intra-BSS downlink (DL) transmission in a wireless communication system 10.

In this embodiment, it is assumed that the overall operating bandwidth (e.g., 160MHz) of the wireless communication system 10 is divided into a primary channel P80 and a non-primary channel S80. The bandwidth of both the primary channel P80 and the non-primary channel S80 is, for example, 80MHz. The aforementioned bandwidth values for the primary channel P80 and the non-primary channel S80 are merely examples and are not intended to limit the present invention. Under normal circumstances, all devices, including the access point 20 and the wireless communication devices 30A, 30B, and 30C, use the primary channel P80 for channel contention and initial frame exchange. FIG. 3 illustrates the process of the access point 20 performing a downlink data transmission to the wireless communication device 30C within the BSS on the primary channel P80. First, after completing a backoff procedure 310, the access point 20 transmits a request to send (RTS) frame 312 in the form of a physical layer protocol data unit (PPDU). Upon receiving this RTS frame 312 and completing its own backoff procedure 320, the wireless communication device 30C sends back a clear to send (CTS) frame 322 in the form of a PPDU to the access point 20. After the successful RTS/CTS exchange, the access point 20 immediately begins transmitting data 314 as a PPDU containing one or more MAC protocol data units (MPDUs) to the wireless communication device 30C. After the data transmission is complete, the wireless communication device 30C sends back a block acknowledgement (BA) frame 324 in the form of a PPDU to the access point 20. When the access point 20 successfully receives the block acknowledgement frame 324, it signifies the end of this transmit opportunity (TXOP) for the access point 20.

In wireless communication protocols, the series of exchanges of specific frames between communication devices to complete a full data transmission is known as a frame exchange sequence (FES). For example, the complete flow consisting of the RTS frame 312, the CTS frame 322, the data 314, and the block acknowledgement frame 324 constitutes a typical frame exchange sequence. When this frame exchange sequence (FES) is completed, the access point 20 and the wireless communication device 30C will each enter the next round of backoff procedures 316 and 326.

Meanwhile, the wireless communication devices 30A and 30B, which have established a TDLS link, will continuously listen to the primary channel P80 while performing their initial backoff procedures 330 and 340. Upon detecting the RTS frame 312 transmitted by the access point 20, the wireless communication devices 30A and 30B determine the primary channel P80 is busy and pause their respective backoff procedures. Executing the instructions 33, the processor 31 of wireless communication device 30A and the processor 31 of wireless communication device 30B are configured to detect, via the primary channel P80, a first PPDU (e.g., the PPDU containing data 314) sent by the access point 20. According to the method of the present invention, upon detecting the first PPDU, the processor 31 is further configured to parse header information of the first PPDU to verify that the first PPDU is an intra-BSS downlink transmission not destined for itself. This verification is important to prevent a TDLS device from incorrectly triggering an NPCA procedure based on an uplink transmission from its peer device, which could lead to link desynchronization. The determination of whether a PPDU is an intra-BSS transmission can be performed by analyzing information from either the MAC header or the PHY header.

Specifically, as one implementation method, the processor 31 may examine the MAC header of the frame encapsulated within the first PPDU. First, the processor 31 determines that the first PPDU is an intra-BSS downlink transmission by identifying a Basic Service Set Identifier (BSSID) in the header that matches the BSSID of its own BSS and by identifying that the transmitter address (TA) corresponds to the MAC address of the access point 20. Second, the processor 31 determines that the first PPDU is not directed to itself by comparing the receiver address (RA) in the header with its own MAC address and finding no match.

Alternatively or additionally, the processor 31 may analyze the PHY header information, often provided by the transceiver in a receive vector (RXVECTOR). Examining the MAC header provides a direct verification of the frame's origin and destination, whereas analyzing the PHY header can be a more efficient alternative for rapid classification. For instance, the processor 31 can classify the PPDU as an intra-BSS downlink transmission if a set of conditions are met. For example, according to the IEEE 802.11bn standard, a received PPDU is classified as an intra-BSS PPDU if it is a specific type of multi-user PPDU (e.g., a UHR MU PPDU) where the RXVECTOR indicates it is a downlink frame (e.g., UPLINK_FLAG is 0), the PPDU_TYPE parameter corresponds to a specific value (e.g., 1 or 2), and at least one of the BSS color fields in the RXVECTOR (such as BSS_COLOR or BSS_COLOR_2) matches either the BSS color of the device's own BSS or the BSS color of a TDLS link in which the device participates, and the BSS color mechanism is not disabled.

In response to determining that the first PPDU is an intra-BSS downlink transmission and is not directed to itself, the processor 31 of wireless communication device 30A (and similarly, the processor of wireless communication device 30B) initiates an intra-BSS non-primary channel access (intra-BSS NPCA) procedure at time T1. Specifically, the processor 31 controls the transceiver 35 to switch together with wireless communication device 30B from the currently occupied primary channel P80 to an idle non-primary channel S80. After switching to the non-primary channel S80, and upon completing a new backoff procedure 332, the wireless communication device 30A can then execute another frame exchange sequence (FES) with the wireless communication device 30B. This NPCA procedure on the non-primary channel comprises transmitting a second PPDU (e.g., the PPDU containing data 334) to the wireless communication device 30B. Upon successfully receiving the data 334, the wireless communication device 30B sends back an acknowledgement (ACK) frame 342 in the form of another PPDU to the wireless communication device 30A.

By implementing the method disclosed herein, the wireless communication device 30A and the wireless communication device 30B can complete their own tunneled direct link setup (TDLS) data exchange on the non-primary channel S80 during the period when the access point 20 is conducting other communications on the primary channel P80. After completing the TDLS transmission, the wireless communication device 30A and the wireless communication device 30B will switch back to the primary channel P80 and continue with subsequent backoff procedures 336 and 344. This approach avoids idle waiting caused by intra-BSS interference, thereby significantly improving the bandwidth utilization efficiency of the entire wireless network.

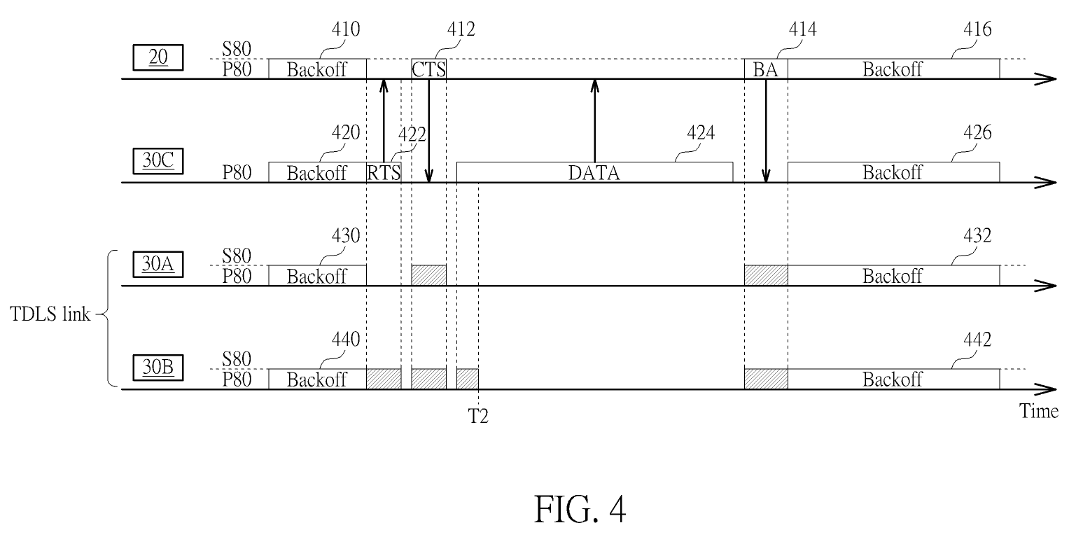

Please refer to FIG. 4, which illustrates a timing diagram according to another embodiment of the present invention, for explaining how wireless communication devices 30A and 30B, which have established a TDLS link, jointly decide whether to execute a non-primary channel access (NPCA) procedure upon detecting an intra-BSS uplink (UL) transmission in the presence of a hidden node. In wireless communication networks, the hidden node situation is prevalent. For example, the wireless communication device 30A may be unable to directly detect transmissions from the wireless communication device 30C due to distance, obstacles, or other signal attenuation factors, even though both are within the signal coverage of the access point 20. This embodiment illustrates how the method of the present invention operates in the presence of a hidden node. As shown in FIG. 4, the non-TDLS station, wireless communication device 30C, intends to transmit uplink (UL) data to the access point 20. A "non-TDLS station" refers to a station within the BSS that is not currently engaged in a TDLS communication link; instead, its communications go through the access point 20. The foresaid uplink communication primarily occurs on the primary channel P80. First, after completing a backoff procedure 420, the wireless communication device 30C transmits a request to send (RTS) frame 422 in the form of a PPDU at time T2. Upon receiving the RTS frame 422 and completing its own backoff procedure 410, the access point 20 sends back a clear to send (CTS) frame 412 in the form of a PPDU to the wireless communication device 30C. Subsequently, the wireless communication device 30C begins transmitting data 424 as a PPDU containing one or more MPDUs to the access point 20. After the data transmission is complete, the access point 20 sends back a block acknowledgement (BA) frame 414 in the form of a PPDU. When the wireless communication device 30C successfully receives the block acknowledgement frame 414, it signifies the end of this transmit opportunity (TXOP) for the wireless communication device 30C. Thereafter, the access point 20 and the wireless communication device 30C will each enter the next round of backoff procedures 416 and 426.

Meanwhile, the wireless communication devices 30A and 30B, which have established a TDLS link, will also continuously listen to the primary channel P80 while performing their initial backoff procedures 430 and 440, respectively. To handle the hidden node situation, according to an embodiment of the present invention, the wireless communication devices 30A and 30B can pre-exchange the media access control (MAC) address list (such as the MAC address list 34 in FIG. 2) of other stations they can detect within the BSS. In this scenario, when the wireless communication device 30C begins its uplink transmission, the wireless communication device 30B is able to detect the PPDU (e.g., RTS frame 422 or data 424) sent by the wireless communication device 30C. However, due to the hidden node, the wireless communication device 30A cannot detect the signal from the wireless communication device 30C. Although both wireless communication device 30A and 30B can detect the CTS frame 412 sent by the access point 20 and learn from it that the subsequent transmission will be initiated by the wireless communication device 30C, in accordance with an aspect of the present invention, the wireless communication device 30A and the wireless communication device 30B will only jointly initiate the NPCA procedure if both are able to identify the transmitter address (TA) or the receiver address (RA) of the frame.

Since the wireless communication device 30A cannot detect the PPDU with the wireless communication device 30C as the transmitter, based on the pre-exchanged information, the wireless communication device 30B can know that the wireless communication device 30A is in a hidden node state. Therefore, the condition for initiating NPCA is not met. As a result, the wireless communication device 30A and the wireless communication device 30B will not perform a channel switch but will continue their backoff procedures (432 and 442, respectively) on the primary channel P80 until the uplink transmission of the wireless communication device 30C is finished. This mechanism ensures that NPCA is initiated only when both parties in the TDLS link can confirm the channel status and perform a synchronized switch, thereby preventing unilateral channel switching and subsequent communication failures caused by hidden nodes.

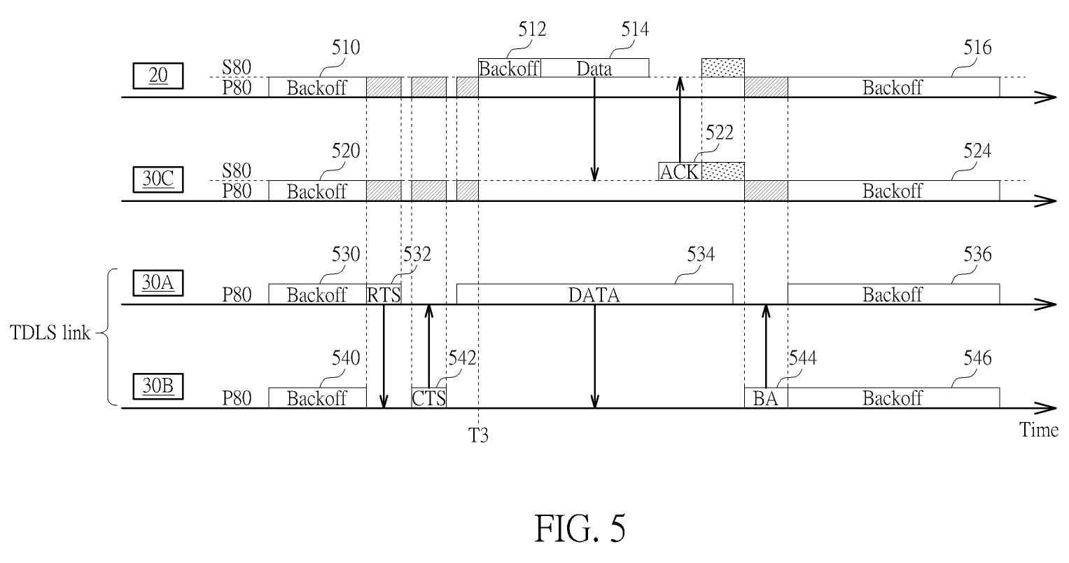

Please refer to FIG. 5, which illustrates a timing diagram according to yet another embodiment of the present invention, for explaining how an access point 20 and a non-AP station 30C execute a non-primary channel access (NPCA) procedure upon detecting an intra-BSS PPDU from a tunneled direct link setup (TDLS). As shown in FIG. 5, the wireless communication device 30A and the wireless communication device 30B, having established a TDLS link, are preparing to exchange data on the primary channel P80. First, after completing a backoff procedure 530, the wireless communication device 30A transmits a request to send (RTS) frame 532 in the form of a PPDU to the wireless communication device 30B. After completing its own backoff procedure 540, the wireless communication device 30B responds by sending back a clear to send (CTS) frame 542 in the form of a PPDU. Meanwhile, the access point 20 and the non-TDLS station, wireless communication device 30C, continuously listen to the primary channel P80 while performing their respective backoff procedures 510 and 520, and pause the backoff procedures upon detecting the RTS frame 532. Therefore, both the access point 20 and the wireless communication device 30C can detect the frame exchange (i.e., RTS frame 532 and CTS frame 542) conducted by the wireless communication device 30A and 30B on the primary channel P80. According to the method of the present invention, the access point 20 and the wireless communication device 30C are able to parse the header information of the PPDU and determine from the header information that the PPDU belongs to an intra-BSS transmission and that neither the receiver address (RA) nor the transmitter address (TA) of the frame is directed to themselves. Based on the above determination, the access point 20 and the wireless communication device 30C can initiate an intra-BSS non-primary channel access (intra-BSS NPCA) procedure at time T3. Specifically, the access point 20 and the wireless communication device 30C will switch together from the currently occupied primary channel P80 to the idle non-primary channel S80. After switching to the non-primary channel S80, and upon completing a new backoff procedure 512, the access point 20 can transmit data 514 to the wireless communication device 30C via the non-primary channel S80 as a PPDU containing one or more MPDUs. Upon successfully receiving the data 514 from the access point 20, the wireless communication device 30C sends back an acknowledgement (ACK) frame 522 to the access point 20 via the non-primary channel S80 in the form of a PPDU. Meanwhile, on the primary channel P80, after receiving the CTS frame 542 from the wireless communication device 30B, the wireless communication device 30A immediately transmits data 534 to the wireless communication device 30B via the primary channel P80 as one or more PPDUs. Upon successfully receiving the data 534 from the wireless communication device 30A, the wireless communication device 30B sends back a block acknowledgement (BA) frame 544 to the wireless communication device 30A via the primary channel P80 in the form of a PPDU.

It is worth noting that this embodiment can also address hidden node situations. For example, the wireless communication device 30C may be unable to directly detect transmissions from the wireless communication device 30A or 30B due to distance or obstacles. In such a scenario, the NPCA procedure is triggered only if both the access point 20 and the wireless communication device 30C can detect the TDLS transmission from the wireless communication devices 30A and 30B. If the wireless communication device 30C is in a hidden node position relative to the TDLS transmission and cannot detect it, the wireless communication device 30C will not initiate the NPCA procedure, even if the access point 20 detects the transmission. This ensures a synchronized channel switch and prevents communication failures that could arise if only one of these devices (i.e., the access point 20 and the wireless communication device 30C) switches to the non-primary channel S80.

After their respective transmissions are completed, all devices will switch back to the primary channel P80 (or remain on the non-primary channel S80 according to the network protocol) and execute subsequent backoff procedures 516, 524, 536, and 546. This embodiment demonstrates the symmetry and flexibility of the method of the present invention; not only can TDLS devices use NPCA to avoid interference from the AP, but the AP and non-TDLS devices can also use NPCA to avoid interference from TDLS devices, thereby maximizing the utilization of bandwidth resources.

In the foregoing embodiments, when a wireless communication device detects intra-BSS interference, it switches to a non-primary channel to perform a non-primary channel access (NPCA) operation. To ensure that the devices intending to communicate can do so successfully on the same channel, the present invention further proposes a method for determining this same channel.

When a wireless communication device detects interference from an intra-BSS PPDU, the target channel for executing the NPCA procedure, i.e., the "NPCA primary channel," can be determined by at least one of the following methods:

In a first method, it is uniformly coordinated by the access point (AP). The access point can announce a designated NPCA primary channel to all stations (STAs) within its BSS. This announcement can be broadcast via a beacon frame, a probe response frame, or other management frames. All stations that receive this announcement will then use the announced channel as the target for switching when an intra-BSS NPCA procedure is subsequently triggered. This AP-announced NPCA primary channel may be the same as or different from the NPCA primary channel originally set for handling inter-BSS interference. The access point can dynamically update this announced channel based on the current network load and channel interference conditions to achieve optimal spectrum resource allocation.

In a second method, it is negotiated by the stations themselves. This method is particularly applicable to non-AP stations that have established a tunneled direct link setup (TDLS). A pair of TDLS stations (e.g., wireless communication devices 30A and 30B) can negotiate a specific NPCA primary channel during the TDLS link establishment process or through subsequent TDLS management frames. This negotiated channel is for the exclusive use of the two stations in this TDLS link. When either station in this TDLS link detects qualifying intra-BSS interference, the pair of TDLS stations will switch together to their self-negotiated NPCA primary channel for communication. This method grants TDLS devices greater autonomy and flexibility.

By using either of the above methods or a combination thereof, it can be ensured that when an intra-BSS NPCA procedure is triggered, the relevant communication devices will have a consistent target channel, thereby successfully completing data exchange on the non-primary channel (i.e., the aforementioned NPCA primary channel) and avoiding communication failures caused by inconsistent target channels.

The method disclosed in the present invention is not only applicable to communication between an access point and stations but can also be widely applied to any peer-to-peer (P2P) communication devices, such as stations performing tunneled direct link setup (TDLS), enabling them to maintain their peer-to-peer communication even when the primary channel is occupied by other transmissions within the same BSS. Furthermore, the NPCA primary channel proposed by the present invention can be highly flexible. The NPCA primary channel can be one of the non-primary channels within the operating bandwidth of the access point's BSS, or it can be a channel entirely outside the operating bandwidth of the access point, thereby providing more diverse channel selection flexibility to adapt to different network environments and interference conditions. The channel switching behavior resulting from the disclosed method can also be detected and verified by commercially available wireless network analyzers (Wi-Fi sniffers), which means that compliance of a device with the method of the present invention is observable and confirmable.

In summary, the present invention discloses a method for non-primary channel access (NPCA) and a related wireless communication device that extends the conventional NPCA mechanism to intra-BSS scenarios. By allowing a switch to a non-primary channel for communication upon detecting a non-self-addressed transmission within the BSS, the method of the present invention can effectively mitigate the effects of intra-BSS interference. This approach avoids unnecessary idle waiting, allows for better utilization of idle channel and bandwidth resources, and thereby improves the overall transmission efficiency and throughput of the wireless communication system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication device operating in a basic service set (BSS), the wireless communication device comprising:
a transceiver configured to receive and transmit a plurality of physical layer protocol data units (PPDUs) on a primary channel and a non-primary channel; and
a processor coupled to the transceiver, the processor configured to:
detect, via the primary channel, a first PPDU;
determine that the first PPDU is an intra-BSS transmission corresponding to the BSS;
determine that the first PPDU is not directed to the wireless communication device; and
in response to determining that the first PPDU is the intra-BSS transmission and is not directed to the wireless communication device, control the transceiver to perform a non-primary channel access (NPCA) procedure on the non-primary channel to transmit or receive a second PPDU.

2. The wireless communication device of claim 1, wherein the first PPDU is a downlink (DL) PPDU transmitted by an access point (AP) of the BSS.

3. The wireless communication device of claim 1, wherein the first PPDU is an uplink (UL) PPDU transmitted by a first station (STA) in the BSS.

4. The wireless communication device of claim 1, wherein the wireless communication device is a non-AP station that communicates with a second station (STA) via a tunneled direct link setup (TDLS).

5. The wireless communication device of claim 4, wherein the processor is further configured to:
exchange, with the second station, a media access control (MAC) address list of a plurality of intra-BSS stations detectable by each other; and
perform the NPCA procedure only when a transmitter address (TA) or a receiver address (RA) of the first PPDU is commonly identified by the wireless communication device and the second station.

6. The wireless communication device of claim 4, wherein the non-primary channel is determined through negotiation by the wireless communication device and the second station.

7. The wireless communication device of claim 1, wherein the wireless communication device is an access point (AP) of the BSS or a non-TDLS station, and the first PPDU is transmitted by a pair of stations performing TDLS communication.

8. The wireless communication device of claim 1, wherein the non-primary channel is announced by an access point (AP) of the BSS.

9. The wireless communication device of claim 1, wherein the non-primary channel is located outside an operating bandwidth of the BSS.

10. A non-primary channel access (NPCA) method for a first wireless communication device, the first wireless communication device and a second wireless communication device operating in a basic service set (BSS) and communicating via a tunneled direct link setup (TDLS), the NPCA method comprising:
detecting, on a primary channel, a first physical layer protocol data unit (PPDU);
determining that the first PPDU is an intra-BSS transmission corresponding to the BSS;
determining that the first PPDU is not directed to the first wireless communication device;
in response to determining that the first PPDU is the intra-BSS transmission and is not directed to the first wireless communication device, switching to a non-primary channel; and
communicating with the second wireless communication device on the non-primary channel.

11. The non-primary channel access (NPCA) method of claim 10, further comprising:
exchanging, with the second wireless communication device, a media access control (MAC) address list of a plurality of intra-BSS stations detectable by each other; and
wherein switching to the non-primary channel is performed only when a transmitter address (TA) or a receiver address (RA) of the first PPDU is commonly identified by the first wireless communication device and the second wireless communication device.

12. The NPCA method of claim 10, wherein the first PPDU is transmitted by an access point (AP) of the BSS.

13. The NPCA method of claim 10, wherein the first PPDU is transmitted by a non-TDLS station in the BSS.

14. The NPCA method of claim 10, wherein the non-primary channel is announced by an access point (AP) of the BSS.

15. The NPCA method of claim 10, wherein the non-primary channel is determined through negotiation by the first wireless communication device and the second wireless communication device.

16. A non-primary channel access (NPCA) method for a first wireless communication device operating in a basic service set (BSS), the BSS further comprising a second wireless communication device and a third wireless communication device, wherein the second wireless communication device and third wireless communication device communicate via a tunneled direct link setup (TDLS), the NPCA method comprising:
detecting, on a primary channel, a first physical layer protocol data unit (PPDU) transmitted by the second wireless communication device or the third wireless communication device;
determining that the first PPDU is an intra-BSS transmission corresponding to the BSS;
determining that the first PPDU is not directed to the first wireless communication device; and
in response to determining that the first PPDU is the intra-BSS transmission and is not directed to the first wireless communication device, performing an NPCA procedure on a non-primary channel.

17. The NPCA method of claim 16, wherein the first wireless communication device is an access point (AP) of the BSS, and the NPCA procedure comprises communicating with a fourth wireless communication device on the non-primary channel.

18. The NPCA method of claim 16, wherein the first wireless communication device is a non-TDLS station.

19. The NPCA method of claim 16, wherein the non-primary channel is announced by an access point (AP) of the BSS.

20. The NPCA method of claim 16, further comprising switching back to the primary channel after the NPCA procedure is completed.
